(19) United States
(12) Patent Application Publication
(10) Pub. No.: US 2024/0218707 A1
(43) Pub. Date: Jul. 4, 2024

(54) Sliding Door Stop

(71) Applicant: Marco A. Hernandez, Coachella, CA (US)

(72) Inventor: Marco A. Hernandez, Coachella, CA (US)

(21) Appl. No.: 18/404,814

(22) Filed: Jan. 4, 2024

Related U.S. Application Data
(60) Provisional application No. 63/437,054, filed on Jan. 4, 2023.

(51) Int. Cl. E05B 65/08

(52) U.S. Cl. CPC E05B 65/0888

(57) ABSTRACT

A door stop for a sliding door assembly includes a support member configured to extend parallel to the passive panel of the sliding door assembly, and a projecting member mounted for movement along the length of the support member. The projecting member extends perpendicular to the passive panel and blocks movement of the active panel of the sliding door assembly in one direction. The support member may be adjustable in length. A releasable locking mechanism for securing the projecting member in a desired location is also provided.

### CROSS-REFERENCE TO RELATED APPLICATIONS

This application claims the benefit under 35 U.S.C. § 119 of U.S. provisional application No. 63/437,054, filed Jan. 4, 2024, entitled “SLIDING DOOR STOP,” the contents of which are incorporated herein by reference.

### BACKGROUND OF THE INVENTION

### 1. Field of the Invention

The present disclosure relates in general to door restraints and, more particularly, to device for limiting the movement of a sliding door.

### 2. Background Art

A dayroom is a secure area in a correctional facility such as a jail or prison, which is contiguous to inmate sleeping areas, and into which inmates may be admitted for activities such as dining, bathing, exercise, leisure activities, or recreation. Typically, access to a dayroom is controlled by a pneumatically operated sliding door.

Fights, riots, or other disturbances occurring in a dayroom of a correctional facility can be extremely dangerous and hard to control. Correctional officers cannot enter the room without fully opening the sliding door, possibly allowing the inmates to rush out. Accordingly, the officers must often resort to throwing hand-sized devices such as clear-out grenades or clear-out cans through relatively narrow openings called pill hatches in the walls or windows of the dayroom. This is ineffective, since inmates can easily block the pill hatches, and can also be risky since the inmates can grab the officers' arms and injure them. In addition, the pill hatches are typically offset with respect to the center of the room, thereby limiting visibility and leaving many blind spots in the dayroom. Larger non-lethal weapons such as pepperball or deuce launchers can also be used, but these do not fit properly through the pill hatch, limiting maneuverability and range of motion.

In some correctional facilities, officers can limit the movement of the sliding door of the dayroom by inserting metal pins into holes that have been drilled in the concrete floor of the facility. However, improper alterations to the concrete floor can compromise the integrity of the floor structure, especially if the building is constructed with post-tension cables or post-tension bars. Ideally, the floor should be inspected using Ground Penetrating Radar before drilling takes place. However, this procedure is costly and time-consuming. If precautions are not taken, the concrete can be disturbed, costing a significant amount of money to repair; worse yet, a post-tension cable could be drilled, resulting in injuries or death.

### SUMMARY

The present disclosure relates to a door stop for use with a sliding door assembly including an active panel mounted for sliding movement in front of a passive panel. The door stop includes a support member configured to extend parallel to the passive panel, and a projecting member mounted for movement along the length of the support member. The projecting member extends perpendicular to the passive panel and blocks movement of the active panel in one direction. The support member may be adjustable in length. A releasable locking mechanism for securing the projecting member in a desired location is also provided.

In one aspect of the disclosure, the projecting member may project from a cylindrical sleeve mounted for sliding movement on the support member, and the releasable locking mechanism may include a set screw extending through the cylindrical sleeve, the set screw having sufficient length to engage an outer surface of the support member when fully tightened.

In another aspect of the disclosure, the support member comprises two tubular sections, with an adjustment mechanism disposed between the two sections to allow adjustment of the distance between them.

In still another aspect of the disclosure, a first pressure plate may be coupled to and extend parallel to one end of the first tubular section and a second pressure plate may be coupled to and extend parallel to one end of the second tubular section. The two pressure plates are configured to exert pressure on the sides of the frame of the fixed panel of the sliding door assembly.

In yet another aspect of the disclosure, the adjustment mechanism may describe a rod having first and second ends, wherein the first end is carried by and fixed with relation to the first tubular section, and the second end is mounted for longitudinal movement within the second tubular section.

In another aspect of the disclosure, the rod may be threaded. Its first end may be carried by a threaded insert in the first tubular member, and its second end may be slidable in a bearing in the second tubular section.

In still another aspect of the disclosure, the rod may pass through at least one threaded insert in a tubular adjustment handle located between the first and second tubular sections.

### BRIEF DESCRIPTION OF THE DRAWINGS

FIG. 1 shows a sliding door assembly in a correctional facility.

FIG. 2 shows a sliding door stop positioned in the passive panel of the sliding door assembly of FIG. 1, with the active panel in a closed position.

FIG. 3 shows a sliding door stop positioned in the passive panel of the sliding door assembly of FIG. 1, with the active panel in a partially open position.

FIG. 4 shows a sliding door stop.

FIG. 5 is a sectional view of area A-A in FIG. 4.

FIG. 6 is a sectional view of Area B-B in FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

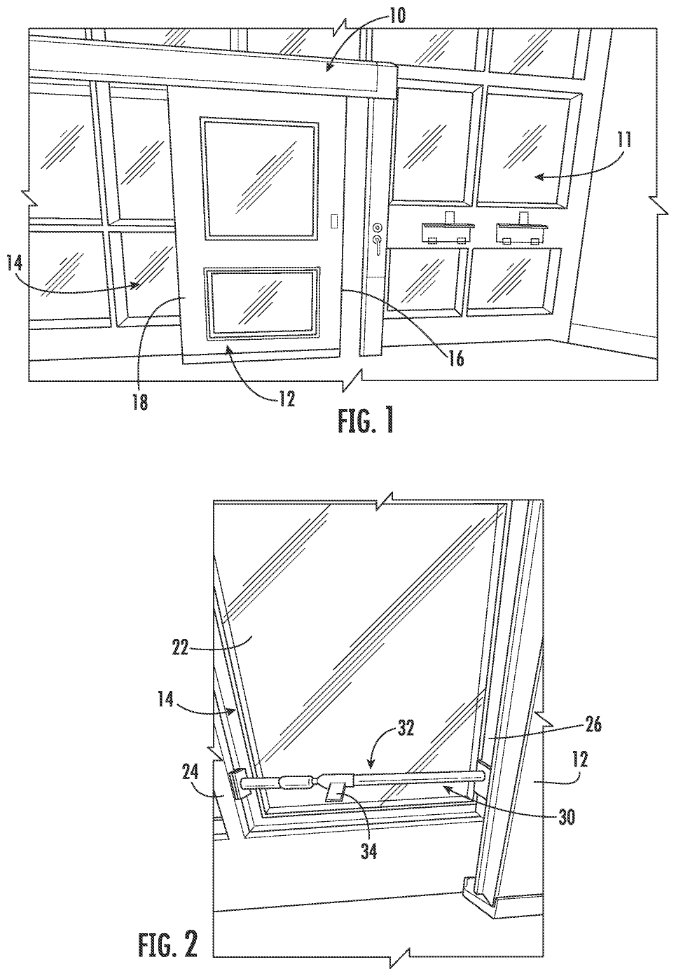

As shown in FIG. 1, the main entrance to the dayroom of a correctional facility typically comprises a sliding door assembly 10 surrounded on both sides by a wall 11 of floor-to-ceiling windows allowing correctional officers to observe the room from outside. The sliding door assembly 10 includes an active panel 12 mounted for sliding movement in front of a fixed panel 14. The active panel 12 comprises a pneumatically operated heavy sliding metal door having a first side 16 and a second side 18. The first side 16 may include a handle and/or latching mechanism. The fixed panel 14 comprises the portion of wall 11 closest to the second side 18 of the active panel.

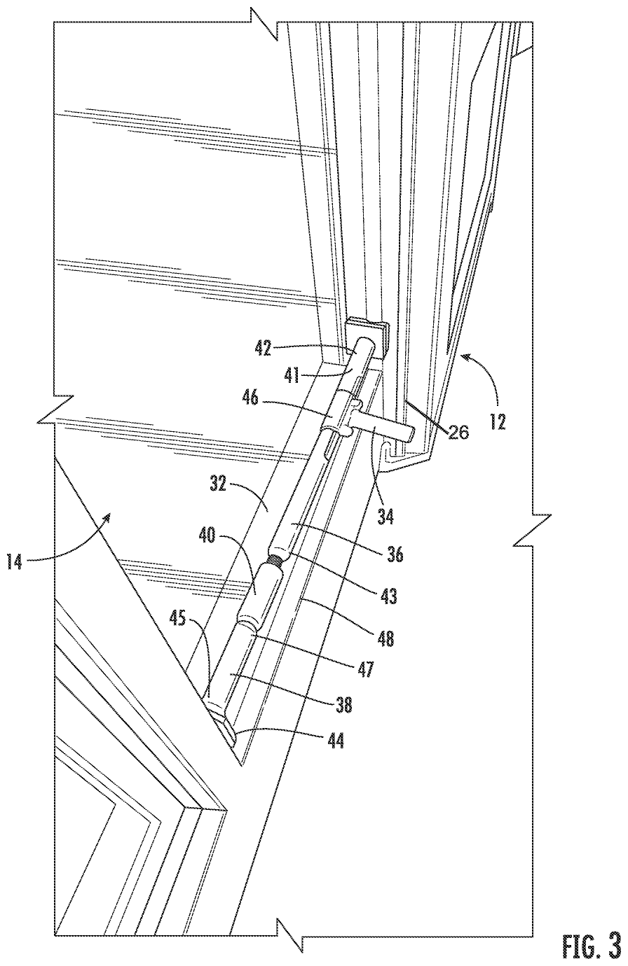

As can best be seen in FIG. 2, the fixed panel 14 comprises at least one pane of glass 22 surrounded by a frame having side frame members 24 and 26 that project forwardly of the glass 22. The sliding door stop 30 of the present disclosure, which is mounted in front of the glass pane 22 between the side frame members 24 and 26, includes an elongated support member 32 and a projecting member 34 that is mounted for sliding movement along the support member 32. In this figure, the projecting member 34 is shown in its most retracted position, which would allow the active panel 12 to slide about 15 inches from the fully closed position.

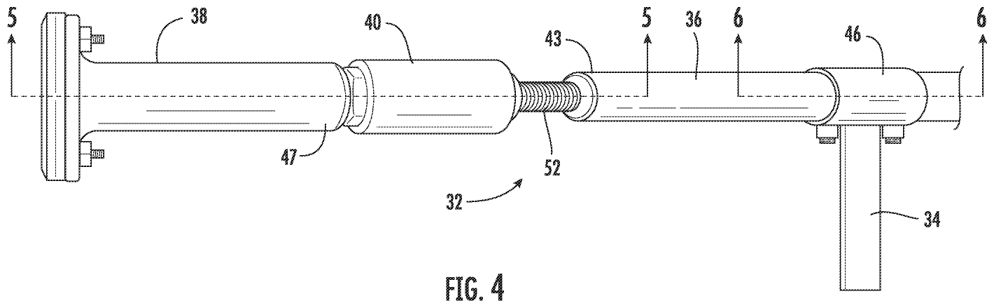

As seen in FIG. 3, the support member 32 includes a first tubular section 36, a second tubular section 38, and an adjustment handle 40 for adjusting the distance between the first and second sections 36, 38. The first tubular section 36 includes a first end 41 secured to a first pressure plate 42, and a second end 43 adjacent to the adjustment handle 40. The second tubular section 38 includes a first end 45 secured to a second pressure plate 44 and a second end 47 adjacent to the adjustment handle 40. The projecting member 34 comprises a rectangular flange that extends perpendicularly to a cylindrical sleeve 46 mounted for sliding movement between the first and second ends 41, 43 of the first tubular end 38. The length of flange must be sufficient to extend well beyond the frontmost edge 48 of the frame of the fixed panel 14 and far enough into the path of the active panel 12 to stop its movement in the opening direction. In this figure, the projecting member 34 has been moved closer to the second side 26 of the frame of the fixed panel 14, allowing the active panel 12 to open less fully.

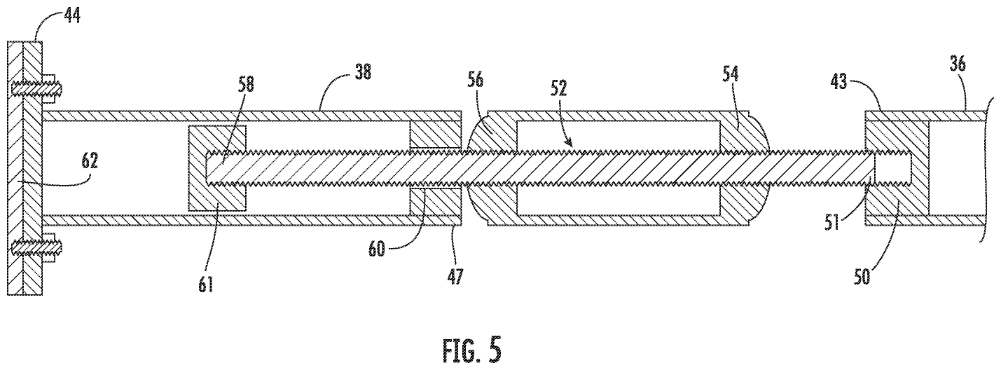

FIGS. 4 and 5 show the support member 32 in greater detail. The second end 43 of the first tubular section 36 contains a first internally threaded insert 50 that receives a first end 51 of an externally threaded rod 52. A central portion 53 of the rod 52 extends through, and is fixed with respect to, second and third internally threaded inserts 54, 56 in opposite ends of the adjustment handle 40, which preferably has a greater diameter than first and second tubular sections 36, 38 in order to provide better grip during adjustment. The second end 58 of the rod 52 passes through, and is slidable with respect to, a non-threaded bearing 60 in the second end 47 of the second tubular section 38. A stop member such as a nut or other internally threaded member 61 on the second end of the rod 52 prevents the rod 52 from being pulled out of the bearing. This arrangement allows for adjusting the effective length of the support member 32, so that it fits securely and tightly between the sides of the fixed panel frame. However, spring-based adjustment mechanisms and other arrangements may also be used.

All components of the support member 32 are made from a strong, durable material such as steel or other metals, since they must be able to withstand the opening and closing forces of a heavy metal door. The pressure plate 44 and its counterpart on the opposite side of the support member 32 may be provided with a backing pad 62 formed of rubber or similar material, which enhances the grip between the support member 32 and the frame of the fixed panel, and prevents the frame from being scratched.

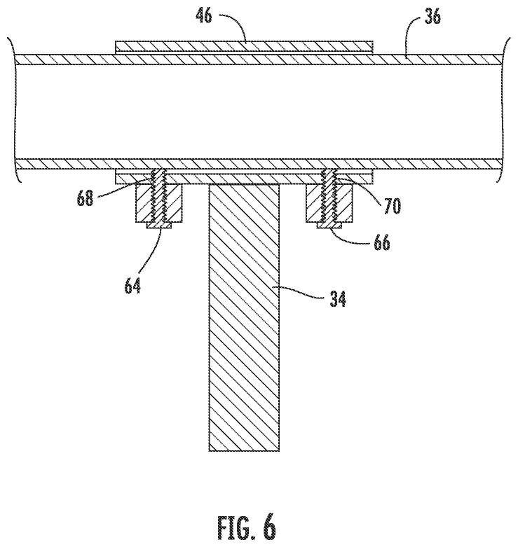

Projecting member 34 and sleeve 46 are best seen in FIG. 6. The sleeve 46 has an inner diameter that is sufficiently greater than the outer diameter of the second tubular section 36 to allow the sleeve 46 to slide easily back and forth when adjusting the distance of the projecting member 34 from the active panel of the door. When the projecting member 34 is at its desired location, it can be locked into place simply by tightening a pair of set screws 64, 66 that extend through openings 68, 70 on either side of the projecting member 34 until the screws 64 engage the outer surface of the second tubular section 36.

Installation and operation of the sliding door stop is extremely quick and easy. Initially, the adjustment handle may need to be rotated in one direction to reduce the length of the support bar 32 to slightly less than the distance between the sides of the frame of the fixed panel. Once the support bar has been inserted in the frame, the adjustment handle is rotated in the opposite direction until the pressure plates press firmly against the sides of the frame. The set screws on the sleeve supporting the projecting member are then loosened, the projecting member is slid into the desired position, and the set screws are again tightened to lock the projecting member in place. Once the door stop is in place, the projecting member prevents the active panel of the sliding door assembly from moving any further in the opening direction, and thus allows correctional officers to safely launch projectiles or other nonlethal weapons into the dayroom without allowing inmates to exit.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A door stop for use with a sliding door assembly including an active panel mounted for sliding movement in front of a passive panel, the door stop comprising:
a support member configured to extend parallel to the passive panel, the support member having a length; and
a projecting member mounted for movement along the length of the support member, the projecting member extending perpendicular to the passive panel and having sufficient length to block movement of the active panel in one direction.

2. A door stop according to claim 1, wherein the support member is adjustable in length.

3. A door stop according to claim 1, further comprising a releasable locking mechanism configured to fix the position of the projecting member relative to the support member.

4. A door stop according to claim 3, wherein:
the projecting member projects from a cylindrical sleeve mounted for sliding movement on the support member; and
the releasable locking mechanism includes a set screw extending through the cylindrical sleeve, the set screw having sufficient length to engage an outer surface of the support member when fully tightened.

5. A door stop according to claim 2, wherein the support member comprises:
a first tubular section;
a second tubular section; and
an adjustment mechanism disposed between the first and second tubular sections and configured to allow adjustment of the distance between the first and second tubular sections.

6. A door stop according to claim 5, wherein the fixed panel includes a frame having a first side and a second side, and further comprising:
a first pressure plate coupled to and extending parallel to one end of the first tubular section and configured to exert pressure on the first side of the frame; and
a second pressure plate coupled to and extending parallel to one end of the second tubular section and configured to exert pressure on the second side of the frame.

7. A door stop according to claim 5, wherein the adjustment mechanism comprises a rod having:
a first end carried by and fixed with relation to the first tubular section; and
a second end mounted for longitudinal movement within the second tubular section.

8. A door stop according to claim 7, wherein:
the rod is threaded;
the first end of the rod is carried by a threaded insert in the first tubular section; and
the second end of the rod passes through, and is slidable with respect to, a bearing in the second tubular section.

9. A door stop according to claim 8, wherein the rod passes through at least one threaded insert in a tubular adjustment handle located between the first and second tubular sections.
